(19) United States
(12) Patent Application Publication
(10) Pub. No.: US 2007/0160021 A1
(43) Pub. Date: Jul. 12, 2007

(54) Methods and apparatus to provide fairness for wireless local area networks that use long network allocation vector (NAV) mechanisms

(76) Inventors: Ariton E. Xhafa, Plano, TX (US); Manish Airy, New Delhi (IN); Jin-Meng Ho, Plano, TX (US)

Correspondence Address: TEXAS INSTRUMENTS INCORPORATED, P O BOX 655474, M/S 3999, DALLAS, TX, 75265, US

(21) Appl. No.: 11/540,102

(22) Filed: Sep. 29, 2006

Related U.S. Application Data
(60) Provisional application No. 60/756,830, filed on Jan. 6, 2006.

(51) Int. Cl. H04Q 7/24

(52) U.S. Cl. 370/338

(57) ABSTRACT

Methods and apparatus to provide fairness for wireless local area networks (WLANs) that use long network allocation vector (NAV) mechanisms are disclosed. A disclosed example method comprises receiving an indication from a station of a wireless network that a long NAV is to be terminated, and sending a contention-free end frame in response to the indication.

### RELATED APPLICATION

This patent claims priority from U.S. Provisional Application Ser. No. 60/756,830, entitled “Fairness in wireless local area networks that use long NAV mechanism” which was filed on Jan. 6, 2006, and which is hereby incorporated by reference in its entirety.

### FIELD OF THE DISCLOSURE

This disclosure relates generally to wireless local area networks (WLANs) and, more particularly, to methods and apparatus to provide fairness for WLANs that use long network allocation vector (NAV) mechanisms.

### BACKGROUND

Wireless local area networks (WLANs) have evolved to become a popular networking technology of choice for residences, enterprises, commercial and/or retail locations (e.g., hotspots). An example WLAN is based on the Institute of Electrical and Electronics Engineers (IEEE) 802.11x family of standards. Today, the IEEE 802.11x family of standards collectively encompass a wide range of physical layer technologies, medium access controller (MAC) protocols, and data frame formats.

### BRIEF DESCRIPTION OF THE DRAWINGS

FIG. 1 is a diagram of an example wireless local area network (WLAN) with an access point and a plurality of wireless stations constructed in accordance with the teachings of the invention.

FIG. 2 illustrates an example manner of implementing an example access point and/or an example wireless station of FIG. 1.

FIGS. 3 and 4 illustrate example long network allocation vector (NAV) termination scenarios for the example WLAN of FIG. 1.

FIGS. 5A and 5B illustrate an example aggregate physical layer convergence procedure (PLCP) protocol data unit (PPDU).

FIGS. 6 and 7 illustrate example manners of implementing the example medium access controller of FIG. 2.

FIGS. 8 and 9 are flowcharts representative of example machine accessible instructions that may be executed to implement the example wireless stations of FIG. 1.

FIGS. 10 and 11 are flowcharts representative of example machine accessible instructions that may be executed to implement the example access point of FIG. 1.

### DETAILED DESCRIPTION

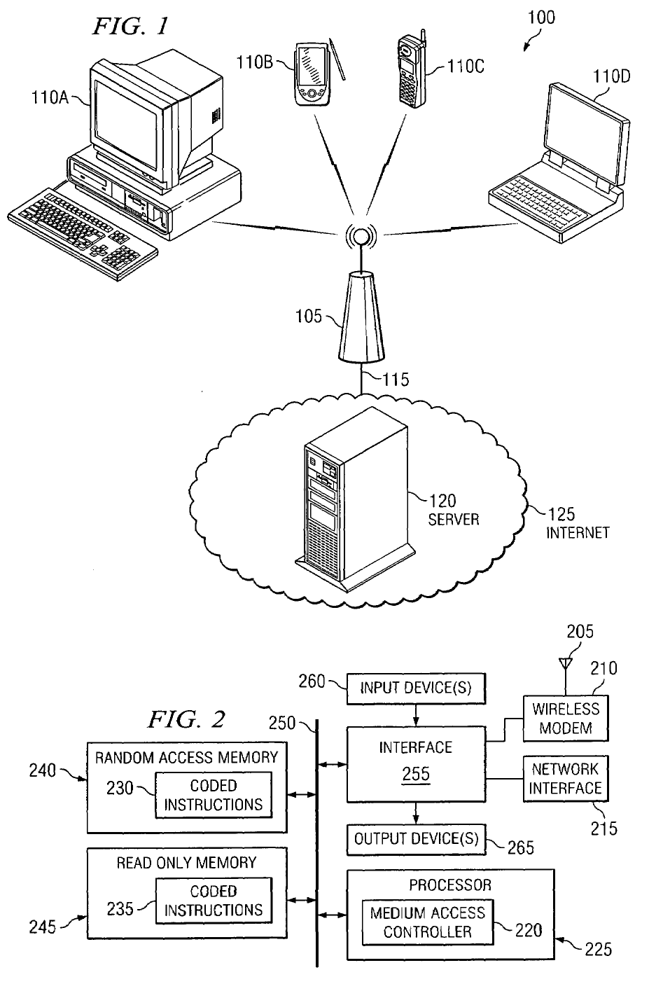

FIG. 1 is a schematic diagram of an example wireless local area network (WLAN) 100. To provide wireless data and/or communication services (e.g., telephone services, Internet services, data services, messaging services, instant messaging services, electronic mail (email) services, chat services, video services, audio services, gaming services, etc.), the example WLAN 100 of FIG. 1 includes an access point (AP) 105 and any of a variety of fixed-location, substantially fixed-location and/or mobile wireless stations (STAs), four of which are respectively designated in FIG. 1 with reference numerals 110A, 110B, 110C and 110D. Example mobile STAs include a personal digital assistant (PDA) 110B, an MP3 player such as an iPod®, a wireless telephone 110C (e.g., a cellular phone, a voice over Internet Protocol (VoIP) phone, a smart phone, etc.), a laptop computer 110D with wireless communication capabilities, etc. Example fixed-location or substantially fixed-location STAs include, for example, any variety of personal computer (PC) 110A with wireless communication capabilities.

The example AP 105 and/or the example STAs 110A-D of FIG. 1 are implemented in accordance with one or more past, present, prevailing and/or future wired and/or wireless communication standards (e.g., one or more past, present, prevailing and/or future standards from the Institute of Electrical and Electronics Engineers (IEEE) 802.11x family of standards) and/or implement features from one or more of those standards. Moreover, the AP 105 and/or any of the STAs 110A-D may implement a similar and/or a different set, subset and/or combination of the IEEE 802.11x standards as the AP 105 and/or any of the other STAs 110A-D.

As used herein, a “legacy” STA 110A-D is implemented in accordance with one or more past and/or current wired and/or wireless communication standards such that the STA 110A-D does not necessarily support one or more features of one or more prevailing, present and/or future wired and/or wireless communication standards such as, for example, the IEEE 802.11n standard currently under development. In the example WLAN 100 of FIG. 1, the STAs 110A-D may represent any combination of legacy and/or non-legacy access points and/or wireless stations.

Some example legacy STAs 110A-D do not support the long and/or extended network allocation vector (NAV) mechanism proposed for the IEEE 802.11n standard. As currently proposed for IEEE 802.11n, the long NAV mechanism allows an IEEE 802.11n capable, interoperable and/or compliant AP 105 and/or STA 110A-D to reserve the wireless medium for an extended period of time to reduce the overhead associated with wireless medium contention. The reserved period of time facilitates the transmission, re-transmission and/or acknowledgement of multiple data frames without requiring repetition of the wireless medium contention procedure(s). However, the reserved period of time is an estimated period of time and, thus, may be different than the actual time required to complete the transmissions. Accordingly, some proposals for the IEEE 802.11n standard provide support for a STA 110A-D and/or AP 105 to terminate the reserved time period early (i.e., terminate a long NAV). However, currently proposed termination mechanisms disadvantage a legacy STA 110A-D that does not support the currently defined long NAV features and/or capabilities of the IEEE 802.11n standard. Moreover, hidden nodes of a STA 110A-D that terminates a long NAV are also disadvantaged. In particular, if a legacy and/or non-legacy STA 110A-D is able to detect the early termination of a long NAV (e.g., receive a termination frame, such as a contention-free end (CF-END) frame, used to terminate the long NAV), then the STA 110A-D can begin contending for the wireless medium. However, if the STA 110A-D cannot detect the early termination (e.g., an error, a hidden node, etc.), then the STA 110A-D must wait until the end of the reserved time period before starting to contend for the wireless medium, thereby putting the STA 110A-D at a disadvantage. Accordingly, the example AP 105 and/or the example STAs 110A-D of FIG. 1 implement apparatus, methods and/or mechanisms to provide and/or ensure fairness when terminating long NAVs such that legacy and non-legacy STAs 110A-D are able to detect the early termination and begin contending for the wireless medium at substantially the same instant.

In the example of FIG. 1, to allow the plurality of STAs 110A-D to communicate with devices and/or servers located outside the example WLAN 100, the example AP 105 is communicatively coupled via any of a variety of communication paths 115 to, for example, any of a variety of servers 120 associated with public and/or private network(s) such as the Internet 125. The example server 120 may be used to provide, receive and/or deliver, for example, any variety of data, video, audio, telephone, gaming, Internet, messaging and/or electronic mail service. Additionally or alternatively, the example WLAN 100 of FIG. 1 may be communicatively coupled to any of a variety of public, private and/or enterprise communication network(s), computer(s), workstation(s) and/or server(s) to provide any of a variety of voice service(s), data service(s) and/or communication service(s) including, for example, any of the services mentioned in the previous sentence.

While a single AP 105 is illustrated in the example of FIG. 1, persons of ordinary skill in the art will readily appreciate that the example WLAN 100 could include one or more of any of a variety of APs 105. For example, to provide wireless data and/or communication services over a site, location, building, geographic area and/or geographic region, a plurality of communicatively coupled APs 105 could be utilized. For instance, a plurality of APs 105 could be arranged in a pattern and/or grid with abutting and/or overlapping coverage areas such that any STA(s) 110A-D located in, and/or moving through and/or within an area communicatively covered by one or more of the plurality of APs 105 can communicate with at least one of the APs 105.

While this disclosure refers to the example WLAN 100, the example AP 105 and/or the example STAs 110A-D of FIG. 1, the example WLAN 100 of FIG. 1 may be used to provide services to, from and/or between any alternative and/or additional wired and/or wireless communication devices (e.g., telephone devices, personal digital assistants (PDA), laptops, etc.). Additionally, although for purposes of explanation, this disclosure refers to the example WLAN 100, the example AP 105 and/or the example STAs 110A-D illustrated in FIG. 1, any additional and/or alternative variety and/or number of communication systems, communication devices and/or communication paths may be used to implement a WLAN and/or provide data and/or communication services. Moreover, while this disclosure references the IEEE 802.11x family of standards and/or long NAV methods proposed for the IEEE 802.11n standard, persons of ordinary skill in the art will appreciated that the methods and apparatus disclosed herein may be utilized for wireless networks operated in accordance with any of a variety of standards such as, for example, the IEEE 801.16x (a.k.a. WiMax) family of standards, and/or to terminate other medium reservation methods and/or mechanisms while ensuring fairness for legacy and/or non-legacy STAs 110A-D.

Similarly, while for purposes of illustration, this disclosure references performing long NAVs and/or termination of long NAVs for the example WLAN 100 of FIG. 1, persons of ordinary skill in the art will readily appreciate that the methods and apparatus disclosed herein may additionally or alternatively be applied to any type of network access control protocol(s), any type of wired and/or wireless communication system(s), and/or any type of network(s).

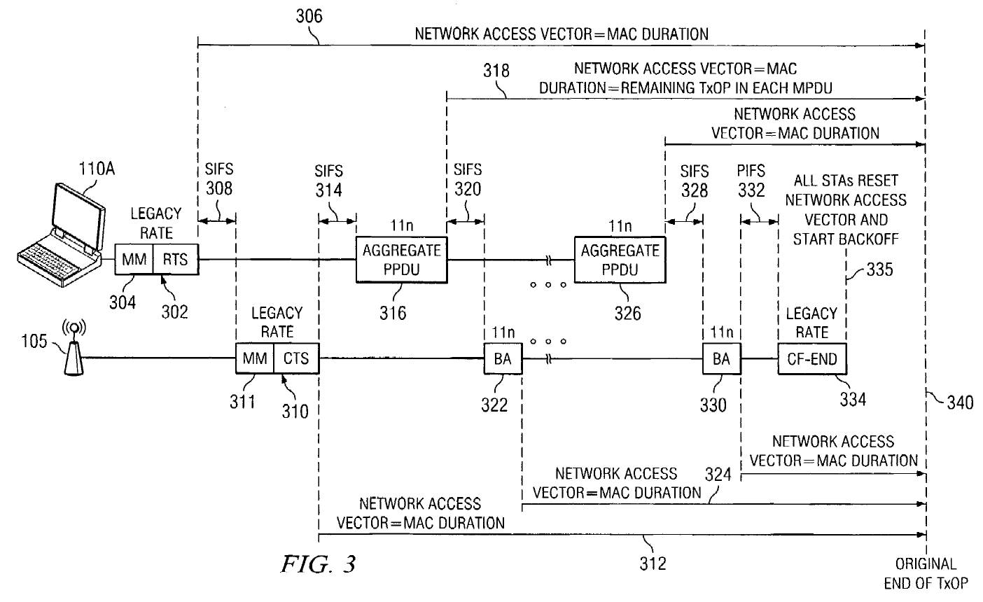

FIG. 2 illustrates an example manner of implementing any of the example AP 105 and/or the example STAs 110A-D of FIG. 1. However, while FIG. 2 can represent the example AP 105 and/or the example STAs 110A-D, for ease of discussion, in the following the example device of FIG. 2 will be referred to as an AP/STA to make clear that the device may be either an AP 105 and/or a STA 110A-D.

To support wireless communications with the example AP 105 and/or one or more of the example STAs 110A-D of the example WLAN 100 of FIG. 1, the example AP/STA of FIG. 2 includes any of a variety of radio frequency (RF) antennas 205 and any of a variety of physical-layer wireless modems 210. The example RF antenna 205 and the example wireless modem 210 of FIG. 2 are able to receive, demodulate and decode WLAN signals transmitted to and/or within the example WLAN 100 of FIG. 1. Likewise, the wireless modem 210 and the RF antenna 205 are able to encode, modulate and transmit WLAN signals from the example AP/STA to the example AP 105 and/or any or all of the example STAs 110A-D of the example WLAN 100 of FIG. 1. Thus, as commonly referred to in the industry, the example RF antenna 205 and the example wireless modem 210 collectively implement the “physical layer” (PHY) for the example AP/STA of FIG. 2.

To communicatively couple the example AP/STA of FIG. 2 to another device and/or network (e.g., a local area network (LAN), the Internet 125, etc.), the example AP/STA of FIG. 2 includes any of a variety of network interfaces 215. An example network interface 215 operates in accordance with any of the IEEE 802.3x (a.k.a. Ethernet) family of standards.

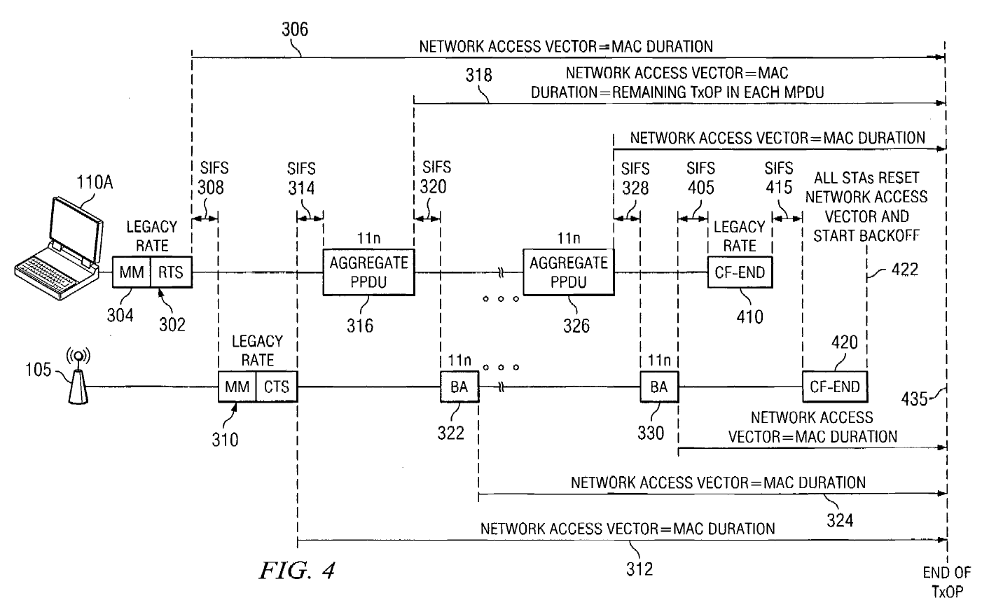

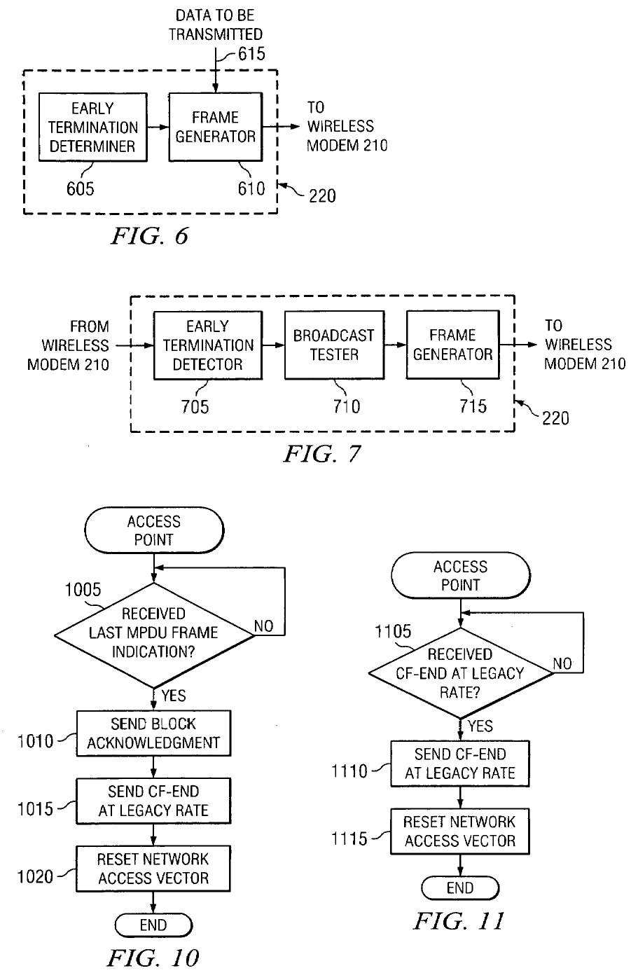

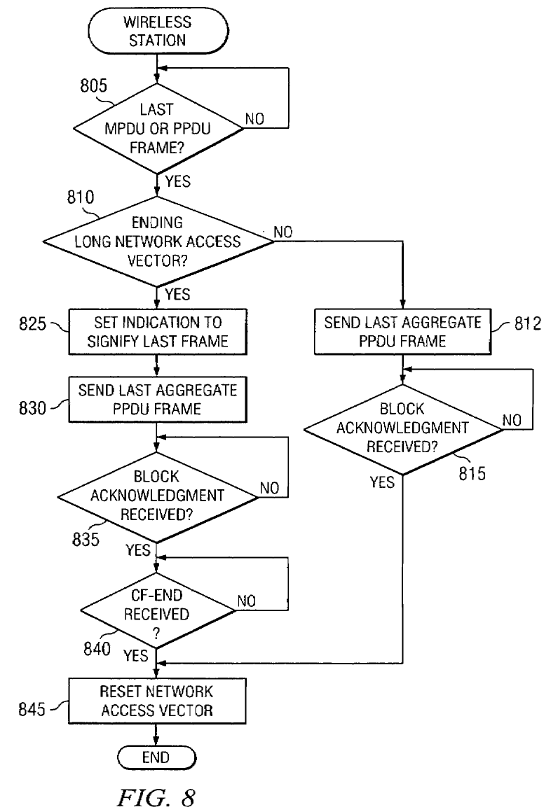

To provide medium access controller (MAC) functionality, the example AP/STA of FIG. 2 includes a MAC 220. In addition to MAC functions, the example MAC 220 of FIG. 2 implements, executes and/or carries out functionality to facilitate, direct and/or cooperate in long NAV mechanisms, and/or terminations of long NAV mechanisms for the example WLAN 100 of FIG. 1. Example methods of implementing the example MAC 220 are discussed below in connection with FIGS. 3-11. In particular, FIGS. 3 and 4 illustrate example long NAV termination scenarios. FIGS. 6 and 7 illustrate example manners of implementing the MAC 220. FIGS. 8-11 illustrate example machine executable instructions that may be carried out to implement the example AP/STA of FIG. 2 and/or to carry out the example scenarios of FIGS. 3 and/or 4.

To implement the example MAC 220 using one or more of any of a variety of software, firmware, processing thread(s) and/or subroutine(s), the example AP/STA of FIG. 2 includes a processor 225. The example processor 225 of FIG. 2 may be one or more of any of a variety of processors such as, for example, a microprocessor, a microcontroller, a digital signal processor (DSP), an advanced reduced instruction set computing (RISC) machine (ARM) processor, etc. The example processor 225 executes coded instructions 230 and/or 235 which may be present in a main memory of the processor 225 (e.g., within a random-access memory (RAM) 240 and/or a read-only memory (ROM) 245) and/or within an on-board memory of the processor 225. The example processor 225 may carry out, among other things, the example machine accessible instructions illustrated in FIGS. 8, 9, 10 and/or 11 to implement the example MAC 220.

While in the illustrated example of FIG. 2, the example MAC 220 is implemented by executing one or more of a variety of software, firmware, processing thread(s) and/or subroutine(s) with the example processor 225, the example MAC 220 of FIG. 2 may be, additionally or alternatively, implemented using any of a variety of application specific integrated circuit(s) (ASIC(s)), programmable logic device(s) (PLD(s)), field programmable logic device(s) (FPLD(s)), discrete logic, hardware, firmware, etc. Also, some or all of the example MAC 220 may be implemented manually or as any combination of any of the foregoing techniques, for example, the MAC 220 may be implemented by any combination of firmware, software and/or hardware.

The processor 225 is in communication with the main memory (including the RAM 240 and the ROM 245) via a bus 250. The example RAM 240 may be implemented by DRAM, SDRAM, and/or any other type of RAM device. The example ROM 245 may be implemented by flash memory and/or any other desired type of memory device. Access to the memories 240 and 245 is typically controlled by a memory controller (not shown). The RAM 240 may be used, for example, to store the wireless medium access contention information, data and/or parameters. One such example parameter is the NAV which is used by the example AP/STA of FIG. 2 for wireless medium access control, to facilitate wireless medium reservations, and/or to reduce and/or manage network congestion. The NAV may be implemented by, for example, a countdown timer and can be used to determine when bandwidth of the example WLAN 100 is available for use by the example AP/STA.

The example AP/STA of FIG. 2 also includes any of a variety of interface circuits 255. The example interface circuit 255 of FIG. 2 may implement any of a variety of interfaces, such as external memory interface(s), serial port(s), general purpose input/output port(s), etc. Additionally or alternatively, the interface circuit 255 may communicatively couple the example wireless modem 210 and/or the network interface 215 with the processor 225 and/or the example MAC 220.

In the example of FIG. 2, any of a variety of input devices 260 and any of a variety of output devices 265 are connected to the interface circuit 255. Example input devices 260 include a keyboard, touchpad, buttons and/or keypads, etc. Example output devices 265 include a display (e.g., a liquid crystal display (LCD)), a screen, a light emitting diode (LED), etc.

While an example manner of implementing the example AT/STA is illustrated in FIG. 2, the AP/STA may be implemented using any of a variety of other and/or additional element(s), processor(s), device(s), component(s), circuit(s), module(s), interface(s), etc. Further, the element(s), processor(s), device(s), component(s), circuit(s), module(s), element(s), interface(s), etc. illustrated in FIG. 2 may be combined, divided, re-arranged, eliminated and/or implemented in any of a variety of ways. Additionally, the example interface 255, the example wireless modem 210, the example network interface 215, the example MAC 220 and/or, more generally, the example AP/STA of FIG. 2 may be implemented as any combination of firmware, software, logic and/or hardware. Moreover, the example AP/STA may include additional processor(s), device(s), component(s), circuit(s), interface(s) and/or module(s) than those illustrated in FIG. 2 and/or may include more than one of any or all of the illustrated processor(s), device(s), component(s), circuit(s), interface(s) and/or module(s).

FIGS. 3 and 4 illustrate example long NAV termination scenarios for the example WLAN of FIG. 1. While the example scenarios of FIGS. 3 and 4 can represent the operation(s) of any of the example STAs 110A-D of FIG. 1, for ease of discussion, the example wireless station illustrated in FIGS. 3 and 4 will be referred to as STA 110A.

In general, the example STA 110A of FIG. 3 indicates to the AP 105 that a long NAV (i.e., an ongoing transmit operation) is to be terminated via an indication included in a transmitted long NAV termination frame (e.g., an aggregate PPDU frame 326). In response to the indication, the example AP 105 of FIG. 3 sends a CF-END frame 334 to terminate the long NAV. Because the example AP 105 of FIG. 3 transmits the CF-END frame, both legacy STAs 110A-D and/or non-legacy STAs 110A-D can receive and/or correctly decode the CF-END frame and, thus, terminate the long NAV at substantially the same moment. Because the AP 105 sends the CF-END frame 326, hidden nodes of the STA 110A can also detect the long NAV termination. Upon termination of the long NAV, the legacy and/or non-legacy STAs 110A-D, and/or the AP 105 can begin contending for the wireless medium at substantially the same time. While in the examples of FIGS. 3 and 4, a last aggregate PPDU frame 326 sent by the STA 110A and a CF-end frame sent by the AP 105 are used to terminate the long NAV, persons of ordinary skill in the art will readily appreciate that any of a variety of long NAV termination frames and/or subsequent long NAV termination response frames could be used. For example, the STA 110A could send a block acknowledge request (BAR) frame with the AP 105 responding with a BA frame to terminate the long NAV.

In more detail, to initiate a transmit operation (TxOP) for which a long NAV is desired, the example STA 110A of FIG. 3 broadcasts any variety of request-to-send (RTS) frame 302. To set the NAV for the TxOP, the example RTS frame 302 of FIG. 3 includes a mixed-mode (MM) preamble 304 that includes a MAC header that contains a duration field. While in the example of FIG. 3, frames (e.g., the example RTS frame 302) include a MM preamble (e.g., the example preamble 304), the frames could alternatively include any one of a variety of legacy preambles and/or headers that include a MAC header that contains a duration field. The content(s) of the duration field of the MAC header are used by the AP 105 and/or each STA 110B-D that receives the example RTS frame 302 to set and/or update their NAV as illustrated with reference numeral 306 in FIG. 3. In the example of FIG. 3, the content(s) of the duration field are set, determined and/or chosen by the STA 110A to cover at least the estimated duration of the TxOP (i.e., the MAC duration of the TxOP). However, the value sent in the duration field may be chosen based upon any of a variety of additional and/or alternative criteria. To ensure that the example RTS frame 302 can be correctly received and/or verified by all STAs 110B-D (including legacy STAs 110B-D), the RTS frame 302 of the illustrated example is sent using a format consistent with any of a variety of legacy transmission technology(-ies) and/or legacy transmission rate(s). Alternatively, the RTS 302 could be sent consistent with any transmission technique and/or transmission rate compatible with all of the STAs 110A-D. Moreover, the example RTS frame 302 could be sending using a format consistent with any of a variety of compatible and/or non-legacy transmission technology(-ies) and/or compatible and/or non-legacy transmission rate(s) such as in accordance with the proposed IEEE 802.11n standard as long as the MAC header of the RTS frame 302 is receivable by all STAs 110A-D.

While the example TxOP of FIG. 3 is initiated to transmit data from the STA 110A to the example AP 105, persons of ordinary skill in the art will recognize that the methods of terminating a long NAV illustrated in FIG. 3 may be used to terminate a long NAV initiated for any of a variety of TxOPs such as, from the STA 110A to one or more of the STAs 110B-D, from the AP 105 to the STA 110A, etc.

After receiving the RTS frame 302, the example AP 105 of FIG. 3 waits a time interval 308 having a duration of at least the Short InterFrame Space (SIFS) and then sends a clear-to-send (CTS) frame 310. Like the RTS frame 302, the example CTS frame 310 of FIG. 3 includes a legacy and/or MM preamble 311 that includes a duration field and is transmitted in a format such that it can be correctly received and/or verified by legacy and/or non-legacy STAs 110A-D. The content(s) of the duration field of the preamble 311 of the CTS frame 310 may be used by the AP 105 and each STA 110B-D that receives the example CTS frame 310 to set and/or update their NAV as illustrated with reference numeral 312 in FIG. 3.

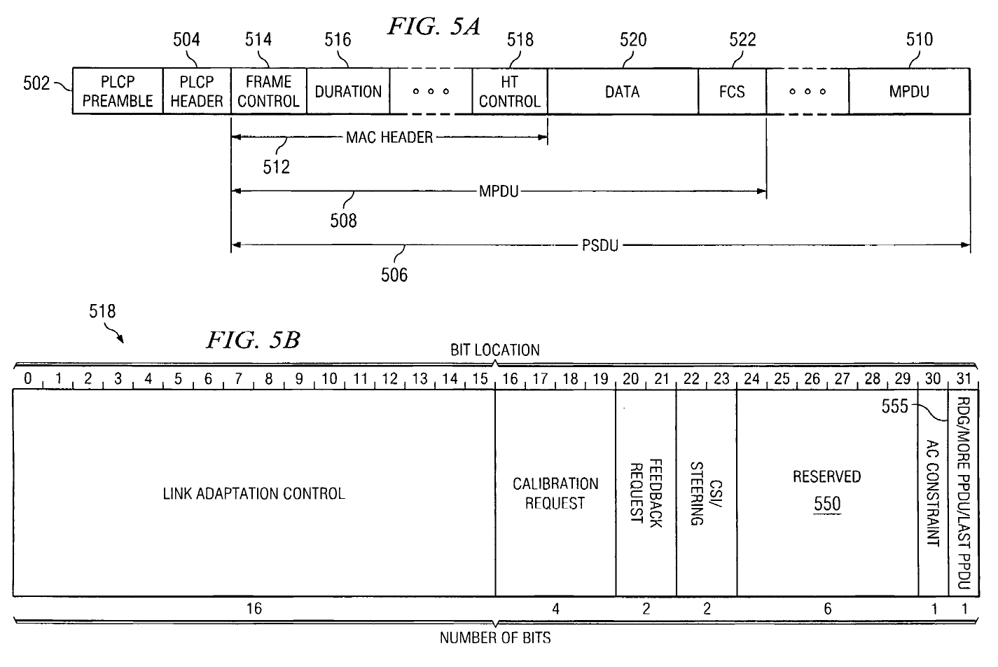

After waiting a time interval 314 having a duration of at least the SIFS, the STA 110A of the illustrated example sends a first frame (e.g., data frame) 316 such as any of a variety of aggregate physical layer convergence procedure (PLCP) protocol data unit (PPDU) frames using any of a variety of transmission technique(s) and/or transmission rate(s) such as a technique and/or rate in accordance with the IEEE 802.11n standard. An example aggregate PPDU frame and HT control information are discussed below in connection with FIGS. 5A and 5B. However, in general, the example aggregate PPDU frames of FIG. 3 include (a) a PLCP preamble, (b) a PCLP header and (c) one or more MAC protocol data units (MPDUs). Moreover, an example MPDU includes (a) a MAC header, (b) any type and/or size of data and (c) a frame check sequence (FCS). Each MPDU may represent one or more encapsulated MAC service data units (MSDUs). In the example of FIG. 3, each MAC header includes a duration field that represents the remaining MAC time duration of the ongoing TxOP (excluding the current aggregate PPDU), and optionally high throughput (HT) control information.

In the illustrated example, the duration field of the MAC header for the last MPDU of the example PPDU frame 316 is used by the AP 105 and/or each non-legacy STA 110B-D that receives the example PPDU frame 316 to set and/or update their NAV as illustrated with reference numeral 318 in FIG. 3.

After receiving the aggregate PPDU 316, the example AP 105 of FIG. 3 waits a time interval 320 having a duration of at least the SIFS. If the aggregate PPDU 316 is received intact (e.g., each MPDU can be verified against its FCS), then the example AP 105 of FIG. 3 sends a response frame such as a block acknowledge (BA) frame 322 using any variety of transmission technique(s) and/or transmission rate(s) such as a technique and/or rate in accordance with the IEEE 802.11n standard. The example BA frame 322 of FIG. 3 includes a duration field that represents the remaining time duration of the ongoing TxOP (excluding the current aggregate BA frame 322). The duration field of the BA frame 322 is used by each non-legacy STA 110B-D that receives the example BA frame 322 to set and/or update their NAV as illustrated with reference numeral 324 in FIG. 3.

The process of sending alternate aggregate PPDU frames and BA frames separated by time intervals having durations of at least the SIFS continues until the STA 110A transmits a last frame that terminates the long NAV (i.e., a long NAV termination frame such as the example aggregate PPDU frame 326). As discussed above and as illustrated in FIG. 3, non-legacy STAs 110A-D and/or the AP 105 continue setting and/or updating their NAV based upon received duration fields.

In the example of FIG. 3, the HT control information for at least one MPDU associated with the aggregate PPDU frame 326 (e.g., the last MPDU of the frame 326) is used by the STA 110A to indicate to the AP 105 that the aggregate PPDU frame 326 is the last PPDU frame of the current ongoing TxOP. Methods of using the HT control information to indicate that the PPDU frame 326 is the last PPDU frame are discussed below in connection with FIG. 5B.

Additionally or alternatively, at least one MPDU of the last aggregate PPDU frame 326 (e.g., the last MPDU of the frame 326) can be formed by the STA 110A to be any variety of NULL frame such as a Quality of Service (QoS) NULL frame to indicate to the AP 105 that the aggregate PPDU frame 326 is the last PPDU of the current TxOP.

After receiving the last aggregate PPDU 326, the example AP 105 of FIG. 3 waits a time interval 328 having a duration of at least the SIFS. If the aggregate PPDU 326 is received intact (e.g., each MPDU can be verified against its FCS), then the example AP 105 of FIG. 3 sends a response frame such as a BA frame 330 using any variety of transmission technique(s) and/or transmission rate(s) such as a technique and/or rate in accordance with the IEEE 802.11n standard.

Because the aggregate PPDU frame 326 conveyed an indication that the aggregate PPDU frame 326 is the last PPDU frame of the current TxOP, the example AP 105 of FIG. 3 waits a time interval 332 after sending the BA frame 330. In the illustrated example, the time interval 332 has a duration of at least the point coordination function (PCF) inter-frame space (PIFS). At substantially the end of the time interval 332, the example AP 105 of FIG. 3 transmits a long NAV termination response frame (e.g., the example CF-END frame 334) such that it can be correctly received and/or verified by all legacy and/or non-legacy STAs 110A-D. In the example of FIG. 3, the CF-END frame 334 is sent using a format consistent with a legacy transmission technique and/or transmission rate. However, the CF-END frame 334 could be sent using any transmission technique and/or transmission rate compatible with all of the STAs 110A-D. The example AP 105 then resets its NAV to, for example, zero (0). However, if during the time interval 332 the AP 105 receives a frame from the STA 110A (e.g., a retransmission of any frame by the STA 110A), the AP 105 responds to the received frame and then restarts the time interval 332. Since such a frame would be transmitted by the STA 110A SIFS time after the BA frame 330, the AP 105 will receive the frame before the time interval 332 expires.

Upon receipt and/or verification of the CF-END frame 334 (i.e., long NAV termination response frame), legacy and/or non-legacy STAs 110A-D reset their NAV to, for example, zero (0), thereby terminating the long NAV for the current TxOP. Because the CF-END frame 334 is transmitted such that legacy and/or non-legacy STAs 110A-D can receive and/or verify the CF-END frame 334, legacy and/or non-legacy STAs 110A-D terminate the long NAV at substantially the same moment as illustrated in FIG. 3 with reference numeral 335.

After detecting the termination of the long NAV at substantially the time 335, legacy and/or non-legacy STAs 110A-D and/or the AP 105 perform any of a variety of backoff procedures such as those defined in the IEEE 802.11x family of standards before attempting to transmit. In general, a STA 110A-D and/or AP 105 waits a time interval having a duration of at least the distributed inter-frame space (DIFS), and then randomly selects a slot of contention window and/or backoff window. When a STA's randomly selected slot arrives, the STA can attempt to transmit. As illustrated in FIG. 3, since the long NAV was terminated early at substantially instant 335, the legacy and/or non-legacy STAs 110A-D, and/or the AP 105 begin contending for the wireless medium at instant 335 before the original MAC duration would have expired (i.e., before the instant illustrated with reference numeral 340 in FIG. 3.

In general, in the example scenario of FIG. 4, the STA 110A terminates a long NAV by sending a CF-END frame as a long NAV termination frame. To ensure that all other STAs 110B-D (including legacy STAs 110A-D and/or possibly hidden nodes with respect to the example STA 110A) can receive and/or correctly detect the long NAV termination, the AP 105 sends a second CF-END frame (i.e., a long NAV termination response frame) in response to the CF-END frame transmitted by the STA 110A. Because the AP 105 transmits the second CF-END frame, all STAs 110B-D (including legacy STAs 110B-D and/or hidden nodes 110B-D) of the AP 105 can receive and/or correctly decode the second CF-END frame and, thus, terminate the long NAV at substantially the same moment and, thus, begin contending for the wireless medium at substantially the same time.

Because the first portion of the example scenario of FIG. 4 is identical to that discussed above in connection with FIG. 3, the description of the first portion is not repeated here. Instead, identical frames and time intervals are illustrated with identical reference numerals in FIGS. 3 and 4, and the interested reader is referred back to the descriptions presented above in connection with FIG. 3 for a complete description of those like numbered frames and time intervals.

Like the example scenario of FIG. 4, the process of sending alternate frames and response frames (e.g, aggregate PPDU frames and BA frames) (including the example last PPDU frame 326 and the example BA 330) separated by time intervals having durations of at least the SIFS continues until the STA 110A reaches a last frame (e.g., a last aggregate PPDU frame 326). As discussed above and as illustrated in FIG. 4, non-legacy STAs 110A-D and/or the AP 105 continue setting and/or updating their NAV based upon received duration fields.

After receiving the aggregate example BA 330 sent by the AP 105 to acknowledge receipt of the last aggregate PPDU 326, the example STA 110A of FIG. 4 waits a time interval 405 having a duration of at least the SIFS. At substantially the end of the time interval 405, the example STA 110A of FIG. 4 transmits a long NAV termination frame (e.g., the CF-END frame 410) that can be correctly received and/or verified by the example AP 105, and/or legacy and/or non-legacy STAs 110B-D. However, persons of ordinary skill in the art will readily recognize that hidden STAs 110B-D of the example STA 110A may not receive the example CF-END 410.

To ensure that all STAs 110A-D of the AP 105 are able to detect the termination of the long NAV, the example AP 105 of FIG. 4 waits a time interval 415 having a duration of at least the SIFS and then transmits a long NAV termination response frame (e.g., the CF-END frame 420) that legacy and/or non-legacy STAs 110A-D can receive and/or verify. The example AP 105 then resets its NAV to, for example, zero (0).

Additionally or alternatively, the AP 105 can use a proximity and/or distance from the STA 110A to the AP 105 to decide whether or not to transmit the second CF-END frame 420. For example, if the STA 110A is close to the AP 105 such that the chances of a hidden node are small, the example AP 105 of the illustrated example does not send the second CF-END frame 420 to thereby reduce the overhead associated with the second CF-END frame 420 (i.e., the time of the wireless medium used to terminate the long NAV). Alternatively or additionally, the AP 105 could also compare the amount of remaining reserved time to a pre-determined threshold. If not enough unused reserved time remains, the example AP 105 could skip sending the second CF-END frame 420. Any of a variety of additional and/or alternative criteria could be used by the example AP 105 of FIG. 4 to determine whether or not to send the second CF-END frame 420.

Upon receipt and/or verification of the second CF-END frame 420, legacy and/or non-legacy STAs 110A-D reset their respective NAV values to, for example, zero (0) thereby terminating the long NAV for the current TxOP. Because the CF-END frame 420 is transmitted such that legacy and/or non-legacy STAs 110A-D can receive and/or verify the CF-END frame 420, legacy and/or non-legacy STAs 110A-D terminate the long NAV at substantially the same moment, as illustrated with reference numeral 422 in FIG. 4.

After detecting the termination of the long NAV at substantially the time 422, legacy and/or non-legacy STAs 110A-D and/or the AP 105 perform any of a variety of backoff procedures such as those defined in the IEEE 802.11x family of standards before attempting to transmit. In general, a STA 110A-D and/or AP 105 waits a time interval having a duration of at least the distributed inter-frame space (DIFS), and then randomly selects a slot of contention window and/or backoff window. When a STA's randomly selected slot arrives, the STA can attempt to transmit. As illustrated, since the long NAV was terminated early at time 422, the legacy and/or non-legacy STAs 110A-D, and/or the AP 105 begin contending for the wireless medium before the original MAC duration expires at a time illustrated in FIG. 4 with reference numeral 435.

In the example of FIG. 4, a non-legacy STA 110B-D that receives the CF-END frame 410 could initiate a time interval having a duration of at least the DIFS and then start contending for the wireless medium. However, because DIFS>SIFS, the receipt of the second CF-END frame 420 terminates that time interval and initiates the example time interval 425. Accordingly, even though a legacy and/or a non-legacy STA 110B-D can detect the termination of the long NAV based on the CF-END frame 410, the legacy and/or the non-legacy STA 110B-D actually start contending for the wireless medium based on the second CF-END 420 as illustrated in FIG. 4.

Persons of ordinary skill in the art will recognize that the example scenarios of FIGS. 3 and 4 are similar. In both examples, the STA 110A indicates to the AP 105 that a long NAV is being terminated via a long NAV termination frame. In the example of FIG. 3, the STA 110A provides the indication to the AP 105 via the last aggregate PPDU frame 326. In the example of FIG. 4, the STA 110A provides the indication to the AP 105 by transmitting the CF-END frame 410. In both illustrated examples, the AP 105 responds to an indication provided by the STA 110A, by transmitting a long NAV termination response frame (e.g. the example CF-END frames 334 or 420) to ensure that legacy and/or non-legacy STAs 110A-D detect the long NAV termination at substantially the same instant and, thus, can begin contending for the wireless medium at substantially the same moment, thereby ensuring fair access to the wireless medium.

While example long NAV termination scenarios have been illustrated in FIGS. 3 and 4, persons of ordinary skill in the art will readily understand that many other long NAV termination scenarios can be implemented using the methods and apparatus disclosed herein.

FIG. 5A illustrates an example aggregate PPDU frame that includes HT control information 518 containing a last aggregate PPDU frame indication. FIG. 5B illustrates the example HT control information 518 of FIG. 5A in more detail. To allow a receiver (e.g., a receiver of the example wireless modem 210 of FIG. 2) to acquire and/or synchronize to the aggregate PPDU frame, the example PPDU frame of FIG. 5A includes a PLCP preamble 502. The example PLCP preamble 502 of FIG. 5A includes any number and/or variety of symbols known a prior to the receiver (e.g., defined in a prevailing standard) such that a wireless modem can acquire and/or synchronize its receiver to the aggregate PPDU frame.

To convey any of a variety of physical layer specific parameters, the example aggregate PPDU of FIG. 5A includes a PLCP header 504. The example PLCP header 504 of FIG. 5A includes a length field, a speed field and a frame check sequence field.

To transport data, the example aggregate PPDU of FIG. 5A includes a PLCP specific data unit (PSDU) 506 that is comprised of one or more of any variety of MPDUs, two of which are illustrated in FIG. 5A with reference numerals 508 and 510. The number of MPDUs 508, 510 carried in the example PSDU 506 depends upon, for example, the wireless transmission data rate. The example MPDUs 508, 510 utilize a substantially similar data structure.

Prior to the example PSDU 506 of FIG. 5A being transmitted across a wireless medium, persons of ordinary skill in the art will readily recognize that, for example, any of a variety of scramblers may be used to “whiten” the example PSDU 506 to reduce and/or eliminate strings of ones or zeros.

To provide information related to medium access control, each of the example MPDUs 508, 510 of FIG. 5A includes a MAC header 512. The example MAC header 512 includes, among other things, a frame control information 514, one or more address fields (not shown), and a MAC duration field 516.

To provide information related to HT operations, the example MPDUs 508, 510 of FIG. 5A include HT control information 518 (e.g., the last MPDU 508, 510 of an aggregate PPDU frame). This HT control information 518 need not be included in each MPDU 508, 510. When HT control information 518 is provided in any particular MAC header 512, the HT control information 518 occurs at the end of the MAC header 512 of the particular MPDU 508, 510 and its presence is indicated using the order bit of the example frame control field 514. Example HT control information 518 is discussed below in connection with FIG. 5B.

To provide user data, each example MPDUs 508, 510 include a payload 520. The example payload 520 of FIG. 5A contains between zero (0) and two-thousand three-hundred and twelve (2,312) bits, but other sizes would likewise be appropriate.

To facilitate the detection of correct reception of the MPDU 508, 510, each of the example MPDUs 508, 510 includes a cyclic-redundancy check (CRC) value and/or FCS 522. The example FCS 522 of FIG. 5A allows a receiver to compute a FCS over a received MPDU 508, 510 (possibly excluding the example FCS 522) and then compare the computed FCS to that received via the MPDU 508, 510 to verify correct (e.g., un-errored) receipt of the MPDU 508, 510.

As discussed above in connection with FIG. 3, a QoS NULL frame (e.g., a particular type of MPDU 508, 510) may be used by a STA 110A-D to indicate to an AP 105 that a particular aggregate PPDU frame is the last aggregate PPDU frame of a TxOP (i.e., a long NAV termination frame). An example QoS NULL MPDU 508, 510 includes a MAC header 512 and a FCS 522 but does not include any data 520.

FIG. 5B illustrates an example data structure for the example HT control information 518 of FIG. 5A. In addition to any of a variety of additional fields and/or bits defined in accordance with one or more past, present, prevailing and/or future standards and/or specifications, the example HT control information 518 of FIG. 5B includes a reserved field 550. The example reserved field 550 of FIG. 5B includes 6 bits at bit locations B24 through B29. In particular, the example STA 110A of FIG. 3 may indicate to the AP 105 that a particular MPDU 508, 510 is the last MPDU 508, 510 of a TxOP, by setting a reserved bit 520 at, for example, location B24 to one (1). However, any of the reserved bits 550 could alternatively be used to make this indication to the AP 105.

To indicate if there are any more aggregate PPDUs for a current TxOP, the example HT control information 518 of FIG. 5B includes a RDG/More PPDU/Last PPDU field 555. The example RDG/More PPDU/Last PPDU field 555 of FIG. 5B includes one (1) bit at bit location B31. Accordingly, the example STA 110A of FIG. 3 may indicate to the example AP 105 that a presently considered aggregate PPDU is the last PPDU of a current TxOP by setting the RDG/More PPDU/Last PPDU bit 555 to one (1).

While an example aggregate PPDU is illustrated in FIGS. 5A and 5B, persons of ordinary skill in the art will readily recognize that any of a variety of other data structures may be used to construct an aggregate PPDU, an MPDU and/or HT control information. In particular, the example MPDUs 508, 510 and/or the example HT control information 518 may be constructed using any of a variety of other and/or additional fields and/or data. Further, the fields and/or data illustrated in FIGS. 5A and/or 5B may be combined, divided, re-arranged, eliminated and/or implemented in any of a variety of ways. Moreover, the example data structures of FIGS. 5A and/or 5B may include additional fields and/or data than those illustrated in FIGS. 5A and/or 5B and/or may include more than one of any or all of the illustrated fields and/or data.

FIGS. 6 and 7 illustrate example manners of implementing the example MAC 220 of FIG. 2. FIG. 6 illustrates an example MAC 220 suitable for a STA 110A-D and FIG. 7 illustrates an example MAC suitable for an AP 105.

To determine when a long NAV may be terminated early, the example MAC 220 of FIG. 6 includes an early termination determiner 605. Using any of a variety of method(s), algorithm(s) and/or calculation(s), the example early termination determiner 605 of FIG. 6 determines when and/or if a long NAV for an ongoing TxOp may be terminated early. An example early termination determiner 605 identifies when no more data remains to be transmitted and when excess reserved time remains.

To generate and/or form transmit frames, the example MAC 220 of FIG. 6 includes any of a variety of frame generators 610. The example frame generator 610 of FIG. 6 forms any variety of frames such as CTS frames, aggregate PPDU frames (e.g., the example aggregate PPDU frame of FIG. 5A), CF-END frames based upon data to be transmitted 615 and/or in accordance with any variety of past, present, prevailing and/or future standard and/or specification such as the IEEE 802.11n standard. As directed and/or controlled by the example early termination determiner 605, the example frame generator 610 of FIG. 6 includes and/or incorporates an early termination indication in a particular frame being formed (i.e., creates a long NAV termination frame). For example, the frame generator 610 sets a control and/or header bit, and/or includes a QoS NULL frame as discussed above in connection with FIGS. 3, 4, 5A and/or 5B.

Turning now to FIG. 7, to detect an early termination of a long NAV, the example MAC 220 of FIG. 7 includes an early termination detector 705. The example early termination detector 705 of FIG. 7 detects an early termination indicator provided by and/or received from a STA 110A-D (e.g., detects a long NAV termination frame). For example, the example early termination detector 705 uses a control and/or header bit, and/or a QoS NULL frame to receive and/or detect the early termination indicator.

To determine if the MAC 220 is to broadcast a CF-END frame to terminate a long NAV, the example MAC 220 of FIG. 7 includes a broadcast tester 710. An example broadcast tester 710 uses a distance from and/or a proximity to a STA 110A-D terminating a long NAV to determine if the MAC 220 of FIG. 7 is to transmit the CF-END frame.

To generate and/or form transmit frames, the example MAC 220 of FIG. 7 includes any of a variety of frame generators 715. As directed and/or controlled by the example broadcast tester 710, the example frame generator 715 of FIG. 7 generates a long NAV termination response frame such as a CF-END frame (e.g. the example CF-END frame 334 of FIG. 3 and/or the example CF-END frame 420 of FIG. 4).

FIGS. 8 and 9 are flowcharts representative of example machine accessible instructions that may be executed to implement the example scenarios of FIGS. 3 and/or 4, and/or, more generally, to implement the example STAs 110A-D of FIGS. 1 and/or 2. The example machine accessible instructions of FIGS. 8 and/or 9 may be executed by a processor, a controller and/or any other suitable processing device. For example, the example machine accessible instructions of FIGS. 8 and/or 9 may be embodied in coded instructions stored on a tangible medium such as a flash memory, or RAM associated with a processor (e.g., the example processor 225 discussed above in connection with FIG. 2). Alternatively, some or all of the example flowcharts of FIGS. 8 and/or 9 may be implemented using any of a variety of ASIC(s), PLD(s), FPLD(s), discrete logic, hardware, firmware, etc. Also, some or all of the example flowcharts of FIGS. 8 and/or 9 may be implemented manually or as any combination of any of the foregoing techniques, for example, a combination of firmware, software and/or hardware. Further, although the example machine accessible instructions of FIGS. 8 and 9 are described with reference to the flowcharts of FIGS. 8 and 9, persons of ordinary skill in the art will readily appreciate that many other methods may be employed to implement the example scenarios of FIGS. 3 and/or 4, and/or, more generally, to implement the example STAs 110A-D of FIGS. 1 and/or 2. For example, the order of execution of the blocks may be changed, and/or some of the blocks described may be changed, eliminated, sub-divided, or combined. Additionally, persons of ordinary skill in the art will appreciate that the example machine accessible instructions of FIGS. 8 and/or 9 may be carried out sequentially and/or carried out in parallel by, for example, separate processing threads, processors, devices, circuits, etc.

Persons of ordinary skill in the art will recognize that the example machine accessible instructions of FIGS. 8 and 9 are substantially similar. In both examples, a STA provides an indication to an AP that a long NAV is being terminated. In the example machine accessible instructions of FIG. 8, the STA provides the indication to the AP via a long NAV termination frame (e.g., the example last aggregate PPDU frame 326 of FIGS. 3 and 4, a BAR frame, a last PPDU frame, etc.). In the example machine accessible instructions of FIG. 9, the STA provides the indication to the AP by transmitting a CF-END frame.

The example machine accessible instructions of FIG. 8 begins with a STA (e.g., the example STA 110A of FIG. 3 and/or, more particularly, the example early termination determiner 605 of FIG. 6) waiting to reach the last MPDU and/or last aggregate PPDU of an ongoing TxOP (block 805). When the last MPDU and/or last aggregate PPDU is reached (block 805), the early termination determiner determines if a long NAV should be terminated early (block 810). For example, the early termination determiner determines if the amount of reserved time remaining after receiving a BA frame and sending a CF-END frame exceeds a pre-determined threshold.

If a long NAV is not to be terminated early (block 810), the STA (e.g., the example frame generator 610 of FIG. 6) transmits the last frame of the TxOP (e.g., last aggregate PPDU) (block 812) and then waits to receive an appropriate response frame (e.g., a BA frame) from an AP (e.g., the example AP 105 of FIG. 1) (block 815). When the BA frame is received (block 815), control then exits from the example machine accessible instructions of FIG. 8.

If a long NAV is to be terminated early (block 810), the early termination determiner causes the frame generator to include an indication in the aggregate PPDU frame that the PPDU frame is the last PPDU frame (block 825). For example, the frame generator sets a reserved bit in the HT control information (e.g., the example reserved bit 550 at bit location B24 of FIG. 5B), sets a RDG/More PPDU/Last PPDU bit (e.g., the example RDG/More PPDU/Last PPDU bit 555 of FIG. 5B), and/or include a QoS NULL MPDU frame in the aggregate PPDU frame.

The STA transmits the last aggregate PPDU including the indication (block 830) and then waits to receive a BA frame from an AP (e.g., the example AP 105 of FIG. 1) (block 835). When the BA frame is received (block 835), the STA waits to receive a CF-END frame from the AP (block 840). When the CF-END frame is received (block 840), the STA resets its NAV to, for example, zero (0) (block 845). Control then exits from the example machine accessible instructions of FIG. 8.

If at block 835 or 815, the STA does not correctly receive the BA frame, the STA may perform any of a variety of error handling such as returning control to block 830 or 812, respectively, to re-transmit the last frame (not shown).

The example machine accessible instructions of FIG. 9 begins with a STA (e.g., the example STA 110A of FIG. 3 and/or, more particular, the example early termination determiner 605 of FIG. 6) waiting to reach the last MPDU and/or last aggregate PPDU of an ongoing TxOP (block 905). When the last MPDU and/or last aggregate PPDU is reached (block 905), the early termination detector determines if a long NAV should be terminated early (block 910). For example, the early termination detector determines if the amount of reserved time remaining after receiving a BA frame and sending a CF-END frame exceeds a pre-determined threshold.

If a long NAV is not to be terminated early (block 910), the STA (e.g., the example frame generator 610 of FIG. 6) transmits the last aggregate PPDU (block 912) and then waits to receive a BA frame from an AP (e.g., the example AP 105 of FIG. 1) (block 915). When the BA frame is received (block 915), the STA (e.g., the example frame generator 610 of FIG. 6), control then exits from the example machine accessible instructions of FIG. 9.

If a long NAV is to be terminated (block 910), the frame generator transmits the last aggregate PPDU including the indication (block 925) and then the STA waits to receive a BA frame from an AP (e.g., the example AP 105 of FIG. 1) (block 930). When the BA frame is received (block 930), the frame generator transmits a CF-END frame (block 935) and resets its NAV to, for example, zero (0) (block 938).

The STA then waits to receive a CF-END frame from the AP (block 940). When the CF-END frame is received (block 940), the STA resets its NAV to, for example, zero (0) (block 945). Control then exits from the example machine accessible instructions of FIG. 9.

While not illustrated in FIG. 9, the STA may at block 940 utilize a timeout that allows the STA to not receive the CF-END frame from the AP. For example, the AP may use a proximity detector and not transmit the CF-END frame for a nearby STA. In such examples, the reset of the NAV at block 938 is sufficient, and control exit from the example machine accessible instructions without receiving the CF-END frame at block 940 or resetting the NAV at block 945.

If at block 930 or 915, the STA does not correctly receive the BA frame, the STA may perform any of a variety of error handling such as returning control to block 925 or 912, respectively, to re-transmit the last frame (not shown).

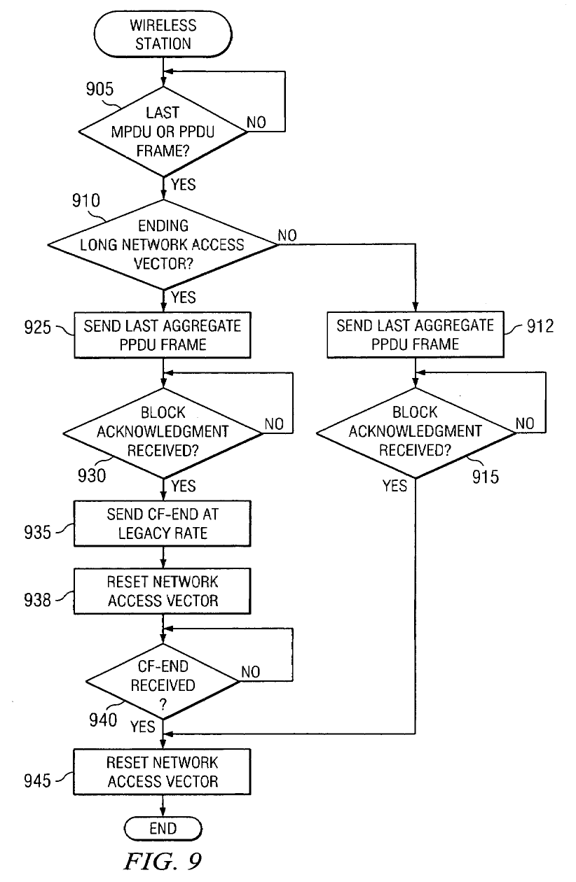

FIGS. 10 and 11 are flowcharts representative of example machine accessible instructions that may be executed to implement the example scenarios of FIGS. 3 and/or 4, and/or, more generally, to implement the example AP 105 of FIGS. 1 and/or 2. The example machine accessible instructions of FIGS. 10 and/or 11 may be executed by a processor, a controller and/or any other suitable processing device. For example, the example machine accessible instructions of FIGS. 10 and/or 11 may be embodied in coded instructions stored on a tangible medium such as a flash memory, or RAM associated with a processor (e.g., the example processor 225 discussed above in connection with FIG. 2). Alternatively, some or all of the example flowcharts of FIGS. 10 and/or 11 may be implemented using any of a variety of ASIC(s), PLD(s), FPLD(s), discrete logic, hardware, firmware, etc. Also, some or all of the example flowcharts of FIGS. 10 and/or 11 may be implemented manually or as any combination of any of the foregoing techniques, for example, a combination of firmware, software and/or hardware. Further, although the example machine accessible instructions of FIGS. 10 and 11 are described with reference to the flowcharts of FIGS. 10 and/or 11, persons of ordinary skill in the art will readily appreciate that many other methods of implementing the example scenarios of FIGS. 3 and/or 4, more generally, to implement the example AP 105 of FIGS. 1 and/or 2 may be employed. For example, the order of execution of the blocks may be changed, and/or some of the blocks described may be changed, eliminated, sub-divided, or combined. Additionally, persons of ordinary skill in the art will appreciate that the example machine accessible instructions of FIGS. 10 and/or 11 may be carried out sequentially and/or carried out in parallel by, for example, separate processing threads, processors, devices, circuits, etc.

Persons of ordinary skill in the art will recognize that the example machine accessible instructions of FIGS. 10 and 11 are substantially similar. In both examples, an AP receives an indication from a STA that a long NAV is being terminated. In the example machine accessible instructions of FIG. 10, the AP receives the indication by receiving a CF-END frame.

The example machine accessible instructions of FIG. 10 begin with an access point (e.g., the example access point 105 of FIG. 3 and/or, more particular, the example early termination detector 705 of FIG. 7) waiting to receive from a STA (e.g., the example STA 110A of FIG. 3) an indication that an aggregate PPDU frame is the last aggregate PPDU frame for an ongoing TxOP (block 1005). For example, the early termination detector may receive the indication via a reserved bit of received HT control information (e.g., the example reserved bit 550 at bit location B24 of FIG. 5B), via a RDG/More PPDU/Last PPDU bit (e.g., the example RDG/More PPDU/Last PPDU bit 555 of FIG. 5B) of received HT control information, and/or via the last aggregate PPDU frame including a QoS NULL MPDU frame.

When an aggregate PPDU frame containing an indication that the aggregate PPDU frame is the last frame of an ongoing TxOP is received (block 1005), the AP (e.g., the example frame generator 715 of FIG. 7) transmits a BA to the STA 110A (block 1010). The frame generator then transmits a CF-END frame such that legacy and/or non-legacy STAs can receive the CF-END frame and, thus, can terminate the current long NAV at substantially the same time (block 1015).

The AP then resets its NAV to, for example, zero (0) (block 1020). Control then exits from the example machine accessible instructions of FIG. 10.

The example machine accessible instructions of FIG. 11 begin with an access point (e.g., the example access point 105 of FIG. 3 and/or, more particularly, the example early termination detector 705 of FIG. 7) waiting to receive from a STA a CF-END frame that indicates the termination of a long NAV (block 1105). When the CF-END frame indicating the termination of the ongoing TxOP is received (block 1105), the AP (e.g., the example frame generator 715 of FIG. 7) transmits a CF-END frame formatted such that legacy and/or non-legacy STAs can receive the CF-END frame and, thus, can terminate the current long NAV at substantially the same time (block 1110).

The AP then resets its NAV to, for example, zero (0) (block 1115). Control then exits from the example machine accessible instructions of FIG. 11.

Additionally or alternatively at block 1110, the AP (e.g., the example broadcast tester 710 of FIG. 7) can use a proximity and/or distance from the STA to the AP to decide whether or not the AP (e.g., the example frame generator 715 of FIG. 7) sends the CF-END frame at block 1110. For example, if the STA is close to the AP such that the chances of a hidden node are small, the broadcast tester causes the frame generator to not send the second CF-END frame at block 1110 to reduce the overhead associated with the second CF-END frame (i.e., the time of the wireless medium used to terminate the long NAV). The broadcast tester could also compare the amount of remaining reserved time to a predetermined threshold. If enough unused reserved time remains at block 1110, the frame generator sends the CF-END frame. Any of a variety of additional and/or alternative criteria could be used by the example broadcast tester at block 1110 to determine whether or not to send the CF-END frame.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. A method comprising:
receiving an indication from a station of a wireless network that a long network allocation vector (NAV) is to be terminated; and
sending a long NAV termination response frame in response to the indication.

2. A method as defined in claim 1, wherein the long NAV termination response frame is a contention-free end frame.

3. A method as defined in claim 1, wherein receiving the indication from the station comprises receiving a long NAV termination frame from the station.

4. A method as defined in claim 3, wherein the long NAV termination frame is a contention-free end frame.

5. (canceled)

6. A method as defined in claim 1, wherein receiving the indication from the station comprises receiving a frame that includes the indication from the station.

7. A method as defined in claim 6, wherein the frame is at least one of an aggregate physical layer control protocol (PLCP) protocol data unit frame or a block acknowledge response frame.

8. A method as defined in claim 6, wherein the indication included in the frame comprises at least one of a bit of a header of the data frame or a null data unit of the data frame.

9-10. (canceled)

11. A method as defined in claim 1, further comprising waiting a time duration that is at least as long as a short interframe spacing before sending the long NAV termination response frame.

12-14. (canceled)

15. A method as defined in claim 1, further comprising:
performing a backoff procedure; and
contending for a wireless medium.

16. A method as defined in claim 1, wherein sending the long NAV termination response frame in response to the indication is conditional on at least one of a proximity or distance to the station.

17. A wireless network access point comprising:
a wireless modem to receive an indication from a station of a wireless network that an ongoing transmit operation is to be terminated; and
a medium access controller to form a long network allocation vector (NAV) termination response frame in response to the indication, wherein the wireless modem is configured to send the termination response frame.

18. A wireless network access point as defined in claim 17, wherein the long NAV termination response frame is a contention-free end frame.

19-21. (canceled)

22. A wireless network access point as defined in claim 17, wherein the indication comprises at least one of a contention-free end frame transmitted by the station or a portion of a frame transmitted by the station.

23. A wireless network access point as defined in claim 22, wherein the portion of the frame comprises at least one of a bit of a header of the frame or a null data unit of the frame.

24-25. (canceled)

26. A wireless network access point as defined in claim 17, wherein the wireless modem is configured to send the long NAV termination response frame such that all nodes of the wireless network can decode the long NAV termination response frame.

27-37. (canceled)

38. An article of manufacture storing machine accessible instructions which, when executed, cause a machine to:
receive an indication from a station of a wireless network that a long network allocation vector (NAV) is to be terminated; and
send a contention-free end frame in response to the indication.

39. An article of manufacture as defined in claim 38, wherein the machine accessible instructions, when executed, cause the machine to receive the indication from the station by receiving a second contention-free end frame from the station.

40. An article of manufacture as defined in claim 38, wherein the machine accessible instructions, when executed, cause the machine to receive the indication from the station by receiving a frame that includes the indication from the station.

41. An article of manufacture as defined in claim 40, wherein the indication included in the frame comprises at least one of a bit of a header of the data frame or a null data unit of the frame.

42-47. (canceled)

48. An article of manufacture as defined in claim 38, wherein the machine accessible instructions, when executed, cause the machine to:
determine a proximity to the station; and
send the contention-free end frame in response to the indication conditional on the proximity.

49-84. (canceled)
